(19) United States
(12) Patent Application Publication
(10) Pub. No.: US 2023/0347293 A1
(43) Pub. Date: Nov. 2, 2023

(54) ELECTRODIALYSIS AND ELECTRODEIONIZATION SPACERS

(71) Applicant: IONIC SOLUTIONS LTD., Rancho Mirage, CA (US)

(72) Inventor: Azaroghly YAZDANBOD, Calgary (CA)

(21) Appl. No.: 18/141,121

(22) Filed: Apr. 28, 2023

Related U.S. Application Data
(60) Provisional application No. 63/336,459, filed on Apr. 29, 2022.

(51) Int. Cl. B01D 61/52; B01D 61/48

(52) U.S. Cl. CPC B01D 61/52; B01D 61/48; B01D 2313/14; B01D 2313/041

(57) ABSTRACT

An improved spacer for use in electrodialysis and electrodeionization stacks can provide close contact between the spacer mesh and its adjacent ion exchange membranes, reducing the water flow cross-section through the cell. This in turn can lead to higher flow velocities and increased flow turbulence between ion exchange membranes, thereby reducing membrane polarization effects and increasing the limiting current density. The improved spacer can be combined with a voluminous spacer gasket for receiving a volume of electroactive media, the voluminous spacer gasket comprising an outer gasket edge having an open central area for receiving the electroactive media, and holes on the top and bottom of the outer gasket edge whose dimensions match the holes on the spacer.

### CROSS REFERENCES TO RELATED APPLICATION

The present application claims the benefit of U.S. Provisional Application No. 63/336,459 filed Apr. 29, 2022, the entire disclosure of which is hereby incorporated by reference.

### FIELD OF THE INVENTION

The present invention relates in general to electrodialysis and electrodeionization systems for desalination, decontamination, softening and deionization of water, and in particular to spacers for use in electrodialysis/electrodeionization stacks which provide improved sealing between stack compartments, reduced output product loss from leakage, reduce membrane polarization effects and therefore reduced energy consumption per unit volume of output product.

### BACKGROUND OF THE INVENTION

Devices employed for removal of dissolved ions from electrolyte solutions using electric fields include electrodialysis and electrodeionization devices. Such devices can be used for desalination of saltwater, softening hard waters, deionization of low conductivity waters, and removal of ionic contaminants from solutions containing such ions.

Electrodialysis systems are typically used for input solutions having a high salt content, for example 1000 mg/liter and higher, such as brackish water and seawater, to produce water for human consumption. In contrast, electrodeionization devices are typically used for production of higher purity products from higher purity feeds, such that the input solutions already have a low salt content and have typically already passed through one or more reverse osmosis systems. Further, while electrodialysis devices typically use rather thin spacers made of a plastic mesh, electrodeionization systems typically incorporate specific, voluminous spacers which are filled with electroactive media such as ion exchange resin beads to facilitate ion flow.

A typical electrodialysis/electrodeionization cell includes the combination of a pair of electrodes each housed in an endplate, a “stack” in between the two endplates, a DC power supply, input fluid flow channels/passages, and output fluid flow channels/passages. A stack is a series of multiple paired chambers, typically arranged into a configuration of alternating anion-selective and cation-selective ion exchange membranes, separated from one another by spacers positioned between adjacent membranes. Diluted or “dilute” compartments alternate between the ion exchange membranes with concentrated or “concentrate” compartments, and these compartments are formed over time by the action of a direct current (DC) electric field transversely passing through the solution filling the volumes between ion exchange membranes when powered by a DC power supply. Ions are accumulated in the concentrate compartments and removed from the dilute compartments.

Spacers are included in the stack in general to create working space between the ion exchange membranes, and they also provide proper fluid flow and hydrodynamics. Starting with the endplates on each side of the stack, there is typically an “end spacer” which, together with the first ion selective membrane, isolates the electrodes located in the endplates from the feed solution passing through the stack, as well as from the product/dilute stream, and the concentrate stream. Alternatively, the electrodes housed in the endplates can be in contact with the feed solution. All of these components and their functions are well-known in the art and are also described below.

In order to provide sufficient sealing towards the outside of the stack and between the compartments within the stack, the open mesh area around the edges of the prior art spacers is typically covered with gasketing material. As a result, even when compressed, the conventional gasketed spacer edges are typically thicker than the open and un-gasketed central mesh areas. This disparity in thickness between the central portion of the spacer and its edges can create gaps between the spacers and their adjacent membranes. The existence of such gaps on one or both sides of the spacer mesh results in a larger flow cross section than would be possible if these gaps did not exist. Thus, since higher flow rates are being imposed on the diluting compartments, the membranes forming the boundaries of the diluting compartments will tend to bulge towards adjacent concentrate compartments and expand the width of the water flow channel between them. This serves not only to increase the electric resistance of the dilute compartments, due to the longer flow path for the ions, but also to increase the chances of membrane polarization, and reduce the water flow velocities. Membrane polarization reduces the desalination capability of the cell, and increases the energy consumption.

“Membrane polarization”, also referred to as “concentration polarization”, is a condition in which the flow of ions through an ion exchange membrane caused by the action of a given electric field intensity is higher than the flow of the same ions in the surrounding solution. This means that more ions move across the membrane than can be supplied by the surrounding solution, such that a highly ion-depleted water layer forms on the surface of the membrane. This ion-depleted water layer has a lower electrical conductivity and higher electric resistivity than the surrounding solution, resulting in a large electrical potential drop across this layer. The practical result is that when this ion-depleted water layer forms, the electrical resistance of the cell increases, and higher electric potential differences (i.e. voltages) must be applied across the cell to maintain a given electric current as is well known by the practitioners of this technology. This condition is also referred to as “ion exchange membranes reaching their limiting current density”, and it occurs more profoundly when lower salinity solutions form the contents of the dilute compartments.

However, if the flow velocity of the water adjacent to the ion exchange membrane is high, potentially leading to increased turbulence within the water stream, this ion-depleted water layer of low salinity and low electrical conductivity is broken up and is mixed with the surrounding solution, reducing or eliminating the membrane polarization effects and increasing the limiting current density. Thus, if the gaps between the spacer mesh and the ion exchange membranes could be reduced/prevented, this would result in a reduced water flow cross-section, in turn leading to higher flow velocities and more turbulence in the water flow between ion exchange membranes. This in turn would reduce or eliminate the membrane polarization effects, and increase the limiting current density.

In both electrodialysis and electrodeionization cells, the “input” or “feed” electrolyte solution is directed through specific flow channels, usually positioned in the endplates. These flow channels work in combination with flow passages in the ion selective membranes and spacers to enable the independent flow of liquids in the concentrate and dilute compartments. Ions present in the feed solution are subjected to an electric field, established through the stack by application of a DC electric potential difference between the electrodes. The passage of the DC current through the stack of alternating anion-selective and cation-selective membranes results in the formation of the alternating dilute and concentrate compartments, with ions being depleted from the liquid flowing through the dilute compartments and accumulated in the adjacent concentrate compartments.

The flow or conduction of ions in electrodialysis/electrodeionization stacks is governed by Ohms law (I=V/R). The electric current (I) of ions is directly proportional to the applied electric potential difference (voltage, V) and is inversely proportional to the electric resistance (R). Since electrodeionization cells typically involve the production of sparingly conductive waters and solutions such as high purity or ultrapure waters, the electric resistivity and resistance of these solutions is so high that the required voltages to establish a reasonable current can become quite excessive. Thus, typically electroactive media (ion exchange resins) are included in the spacers between the membranes to facilitate the flow of ions and define a low resistance path for flow of ions. The use of electroactive media such as ion exchange resins is generally not required in electrodialysis systems that treat high conductivity waters (such as brackish water or seawater) to produce potable water; rather, for these systems, the spacers are typically a mesh made up of woven strands of non-conductive materials such as plastics which allow for flow of water between the membranes. These spacers also typically have punched or cut-out holes with specific gasketed edges for prevention of leaks to the outside of the stack and between the stack compartments that also allow the independent flow of feed water into and out of the dilute compartments and the concentrate compartments, as is well known by the practitioners of this technology. Other functions of spacers in electrodialysis/electrodeionization systems include facilitation of the independent flow of the liquids in the dilute compartments and the concentrate compartments, structural support for the membranes, creation of volume and flow passages within each compartment, and maintenance of separation between adjacent anion-selective and cation-selective membranes.

Conventional electrodialysis/electrodeionization devices typically use conventional metallic electrodes for generation of the DC electric fields within the stack. In these electrodes, charges (electrons) are transferred across the metal-liquid interface. These electron transfers cause oxidation and/or reduction (redox) reactions to occur, depending on electrode polarity. Redox Reactions are governed by Faraday's law (i.e., the amount of chemical reaction products produced by the flow of current is proportional to the amount of electricity passed). Metallic electrodes thus establish electric fields within the solutions surrounding them via “Faraday/Redox” electrode reactions. If the potential difference between each electrode and the solution adjacent to it is less than the minimum potential to allow electrode reaction (charge exchange between the electrode and the ions in the solution adjacent to it) there will be no electric field between the electrodes, and no electric current will pass between the electrodes. Occurrence of Redox Reactions at metallic electrodes in water unavoidably also leads to generation of hydrogen gas at the cathode and oxygen gas at the anode. If the concentration of the chlorides in the solution adjacent to the anode is high, chlorine gas could also be generated.

In some electrodialysis devices the electrodes used are of the capacitive type, capable of absorbing large amounts of ions and capacitively establishing an electric field without the occurrence of electrode reactions. U.S. Pat. No. 10,329,174 to Yazdanbod, which is incorporated herein by reference in its entirety, specifically teaches the use of high electric capacitance electrodes such as electric double layer capacitor (EDLC) electrodes or supercapacitor electrodes, discusses the behavior of such high electric capacitance electrodes in confined containers, the use of high electric capacitance electrodes as means of capacitive generation of electric fields and ionic currents, and polarity reversals as a means of avoiding electrode reactions. The behavior of the stack and its function in creation of dilute compartments and the concentrate compartments is independent of how the electric field is generated. That is, the behavior and function of a given stack in response to the electric field passing through it is the same if the electric field is established by the use of metallic electrodes which function by occurrence of electrode Redox Reactions and generate gases or by capacitive electrodes which establish the electric field by absorption of ions, without electrode reactions. Thus, all the features of the stack and its modes of operation are applicable to cells using metallic or capacitive electrodes or any other means of establishing the electric field therein.

When high recovery of output product (e.g. potable water) is the goal, then a higher proportion of the feed solution can be preferably “pushed” via increased applied pressure through the dilute compartments than the concentrate compartments. However, such an increased pressure differential can put stress on the spacer's seals, causing leakage between the dilute compartments and the concentrate compartments. This leakage can reduce output product recovery and can also lead to the waste of the energy used to produce the output product. To avoid, prevent or reduce leakage between the dilute compartments and the concentrate compartments, current electrodialysis systems on the market will require a limit on the differential pressure that is applied between the compartments, often to rather low values, such as a fraction of one bar. This small pressure differential is also intended to protect the ion exchange membranes from the development of large tension stresses, which could lead to tearing and puncturing of the membranes. Careful experimentation by the present inventor with gasketing patterns around water flow passages on a number of existing prior art spacers has found that appreciable leaking from the dilute compartments to the concentrate compartments can be observed when an increasing differential pressure is applied, as is often desirable in order to achieve high recoveries. In addition, when the goal is to produce highly concentrated products, leakage of the dilute compartments into the concentrate compartments reduces the quality of the output product. The exact mechanism of this leaking phenomenon, and a proposed spacer for preventing it, is described herein.

Prior Art Stacks and Spacers—FIGS. 1-6 illustrate typical prior art stack components used in typical prior art electrodialysis or electrodeionization stacks. Specifically, FIG. 1 shows a single ion exchange membrane sheet 10, including a plurality of equal sized holes 11 near the top end and the same number of equal sized holes 12 near the bottom of the sheet. This sheet can be either an anion exchange membrane or a cation exchange membrane.

FIG. 2 shows two typical prior art spacers 20, 21, for use in electrodialysis stacks, both of which are substantially identical, with spacer 21 being the spacer 20 flipped or turned over along its longer side, as identified by the positions of the triangular cuts 22. Both spacers 20, 21 are made up of a thin plastic mesh 23 (usually less than one millimeter thick), wherein an outline pattern around the perimeter of the sheet, preferably made of a rubber-like compound such as silicon rubber, is infused on the spacer sheet surrounding the plastic mesh 23, forming a gasket 24 structurally connected to the central mesh 23. The outline pattern or gasket 24 covers all the periphery of the spacer on both sides of the spacer sheet, with specific patterns around the punched holes 25 and 26 on the top and holes 27 and 28 on the bottom of spacer 20, and around the punched holes 35 and 36 on the top and holes 37 and 38 on the bottom of spacer 21. That is, holes 26 and 28 of spacer 20, as well as holes 36 and 38 of spacer 21 shown in FIG. 2 are structurally and hydraulically connected to the central mesh 23 via extensions 29. In contrast, holes 25 and 27 of spacer 20, as well as holes 35 and 37 of spacer 21, are structurally and hydraulically isolated from the central mesh 23.

In typical electrodeionization stacks the gasketed spacer edges are rather thick, typically several millimeters, such that they can also allow for placement of electroactive media (resin beads) between the ion exchange membranes. The dimensions and location of the plurality of holes 25 to 28 of spacer 20, and holes 35 to 38 of spacer 21 shown in FIG. 2, are intended to perfectly match with ion exchange membrane holes 11 and 12 presented in FIG. 1. The opposite orientation of spacers 20 and 21 create the conditions that when feed lines, such as water conveyance holes 54 or 57 as shown in FIG. 5 connect to spacer holes 26 and 28 on spacer 20, water flows in the compartment formed between two adjacent ion exchange membranes housing this spacer and can not enter the next compartment housing the next spacer 21 as the gasket material around spacer holes 25 and 27 form a seal between this spacer and the two ion exchange membranes adjacent to it. It is also noted that in some designs the shape of the rectangular extensions 29 is trapezoidal, with the larger base connected to the open mesh area 23 and the smaller base fitting the holes. There are also many variations of the typical spacer shown on FIG. 2 that might look different but are structurally and functionally the same.

FIG. 3 presents an end spacer 30, wherein the central mesh 123 is the same as central mesh 23 in FIG. 2, but, in contrast to the gasketed edge 24 of the spacers 20, 21 shown in FIG. 2, the infused gasketed edge 24 of the end spacer 30 structurally and hydraulically isolates all the water conveyance holes 111, 112 on top and bottom of the end spacer 30 from the central the central mesh 23. With the use of these end spacers 30, and with an ion selective membrane adjacent to it on the stack side of the end spacer, the contents of electrode compartments can be hydraulically isolated from the water flow regimes of the dilute compartments and the concentrate compartments within the stack. As noted above, in all electrodialysis and electrodeionization cells wherein it is intended to separate the electrode compartment solutions from the feed, the dilute solutions, and the concentrate solutions, the stacks have an “end spacer” (e.g. end spacer 30) on each side of the stack that separates the stack from the endplates.

All of the other spacers in the stack which are not end spacers are simply referred to herein as “spacers” such as those represented by spacers 20, 21 in FIG. 2. If a stack, following the end spacer 30, begins at one end of the stack with a cation exchange membrane, then this membrane may be followed by a spacer 20, in turn followed by an anion exchange membrane, and then another spacer 21. This pattern can then repeat until the end spacer 30 at the other end of the stack is reached. Similarly, if a stack starts with an anion exchange membrane, then this membrane can be followed by a spacer in turn followed by a cation exchange membrane and then another spacer oriented in reverse. This pattern then also repeats. In both of the repeating patterns described above, the orientations of spacers 20 and 21 placed in adjacent compartments between ion exchange membranes are opposite of one another. That is, if the spacer following the first ion exchange membrane is oriented like spacer 20 in FIG. 2 with the triangular corner cut on the left side, then the spacer following the next ion exchange membrane can be oriented like spacer 21 in FIG. 2 with the triangular cut on the right side. Such stacks are then placed between the two endplates (e.g. 32, 33 of FIG. 4), which also house the electrodes and input and output water conveyance lines.

FIG. 4 shows a block diagram 31 of a typical electrodialysis/electrodeionization cell in which blocks 32 and 33 are the two endplates, and block 34 represents the stack. In this figure two directional views A-A and B-B are also shown representing the views towards endplate 32 and endplate 33, respectively. FIG. S presents two electrodialysis and/or electrodeionization endplates 40 and 41, which correspond to views A-A and B-B of FIG. 4 respectively, wherein the dashed lines 50 on top and 52 at the bottom of endplate 40, and dashed lines 51 on top and 53 at the bottom of endplate 41 are the water conveyance passages (feed input or output stream) on these end plates that are drilled from the sides of these rather thick (usually 5 to 20 cm thick) end plates. The first end plate 40 is located on one end of the stack 34 of FIG. 4, and the second end plate 41 is placed on the other end of the stack. The connection and valves on these water conveyance passages 50 to 53 are not shown. There are also two cavities 42 and 43 within the endplates 40 and 41, respectively, which house electrodes that are not shown, but are well known to those who practice the art. Water conveyance holes 54, 55, 56 and 57 are at the top and bottom of endplates 40 and 41, and connect to water conveyance passages 50, 51, 52 and 53 entering from the sides of the plates as shown. In FIG. 5, water conveyance holes 54 to 57 correspond to every other of hole 11 and 12 on ion exchange membranes in FIG. 1, with the position of the remaining ion exchange membrane holes indicated as dashed circles by numerals 60, 61, 62 and 63.

Input water coming into the cell from holes/passages 54 on endplate 40 will flow through the spacer-filled compartment between the first ion exchange membrane and the second ion exchange membrane, and repetition of the same with spacers oriented like spacer 20 within the stack and leave the cell from holes/passages 57 on end plate 41. Similarly, when another stream of input feed water enters through holes/passages 56 on end plate 41, it will flow through the spacer-filled compartment between the next two ion exchange membranes, and repetition of the same with spacers oriented like spacer 21 and exit the stack through holes 55 on end plate 40. This means that two sets of compartments are defined in each stack of a cell, each being fed by a separate feed stream, and they are hydraulically isolated from one another, as is well-known by the practitioners of this art.

The result of the above mentioned patterns of flow will be that as these two separate streams flow through the cell, and when the electrodes are connected to a DC current power supply, the electric field generated and passing through the stack can drive the positive and the negative ions in opposite direction of each other, and by interactions with ion exchange membranes result in the formation of dilute compartments adjacent to concentrate compartments, as is also well known in the art. These separate streams are then drawn out continuously or intermittently (e.g. batch operation) as the process proceeds and more feed solution is supplied. Flow directions in one or both of these compartments can also be put in reverse, such that the feed can enter from the bottom and leave from the top of the stack for one or both flows. It is also noted that the feed solutions for the electrode compartments may be distributed into and out of the electrode compartments through lateral conveyance passages connecting to them (not shown), and using the end spacers shown in FIG. 3 may be kept separate from the feed flows forming the dilute streams and the concentrate streams.

With a view to FIG. 4, it is pointed out that the endplates 32, 33 (40, 41 in FIG. 5) support the stack all around the edges, that is, the area outside the electrode cavities 42 and 43 in FIG. 5. These endplates 32, 33 are then compressed against each other and the stack 34, typically by metallic support plates (not shown), and pulled towards one another by a frame system including nuts and bolts (also not shown). Sometimes the bolting system and the endplates are combined, eliminating the need for external support plates. The compression of the stack 34 then allows the gasketed parts such as gasketed edge 24 in FIG. 2 to seal the stack and prevent any leaks to the outside. In this configuration, the endplates and their support plates compress the ion exchange membranes and the spacers outside the central mesh area of the spacer. This supported/compressed area also covers holes and extensions of the mesh identified by numeral 29 in FIG. 2. Since the endplates form rather rigid structures compared to the stack, it can be assumed that there will be uniform compression of the stack over the area supported by the endplates. However, given the fact that the extensions 29 of the spacer mesh are slightly thinner than the gasketed edge 24 of the spacers 20 and 21, it follows that the stress imposed on the extensions of the mesh 29 can be lower than their adjacent gasketed areas. In other words, if we consider two compressed ion exchange membranes and their related spacers, the thickness of the combined two spacers and two ion exchange membranes all around the edges will be equal to thickness of the two ion exchange membranes plus the gasketed thickness of the two spacers. But in the areas identified by numeral 29, this thickness can be equal to the thicknesses of the two ion exchange membranes plus the thickness of the gasketed edge on one spacer and the thickness of un-gasketed bare mesh on the other spacer. Thus, the stack thickness can be the same all around the gaskets and ion exchange membranes, but the areas identified by numeral 29 are thinner, and therefore are compressed less. These areas of lower compressive stress 29 are shown in FIG. 6 (showing two spacers 20 and 21 one on top of the other) that correspond to the same on FIG. 2.

Lower compressive stress on the extensions 29 of the mesh in FIG. 2 causes the seal between the compartments in the stacks to be weaker at these points, compared to the adjacent gasketed areas. Therefore, when an electrodialysis cell with the prior art spacers shown in FIG. 2 is operated with different flow feed pressures (pressure differential) between the dilute and the concentrate feeds (which is often desired in order to accomplish high recovery of dilute product water), product water can leak from the dilute compartments into the adjacent concentrate compartments because of this increased pressure differential. Observations by this inventor on a number of stacks that used the prior art spacers have confirmed this. One of the test stacks used for this observation employed one hundred (100) ion exchange membranes that were 0.35 mm thick and 30 cm by 50 cm in plan area, and spacers that were 0.355 mm thick at the edge (gasketed edge 24 in FIGS. 2) and 0.35 mm thick at the thinner bare mesh parts of the spacers (areas 23 and 29 in FIG. 2). When pressurizing one set of compartments by about one bar of pressure, very visible leaks of several milliliters per second were observed.

Further to the above, and with due attention to FIG. 2, when the thickness of the central mesh section 23 in just about all spacers within a stack is less than the thickness of the edges, then as the cell is operated with higher flow rates imposed on the diluting compartments, then the ion exchange membranes forming the boundaries of diluting compartments can bulge towards the concentrate compartments and expand the width of the water flow channel between them. This will not only increase the electric resistance of the dilute compartment due to longer flow path for ions, but will also reduce the water flow velocity, increasing the potential for ion exchange membrane polarization. As noted above, membrane polarization causes an ion-depleted water layer to form on the surface of the ion exchange membrane, which has a lower electrical conductivity and higher electric resistivity than the remaining solution. As a result, higher voltages must be applied across the cell to maintain a given electric current.

In light of the above, it is apparent that it would be beneficial for electrodialysis and electrodeionization systems to have specific spacers which provide close contact between the spacer mesh and its adjacent ion exchange membranes. It would also be beneficial to provide spacers which can reduce the water flow cross-section through the cell, in turn leading to higher flow velocities and increase flow turbulence between ion exchange membranes. It would also be beneficial to provide spacers which can prevent or resist leakage between the alternating dilute and concentrate compartments of the system, provide better support to the ion exchange membranes, prevent or reduce the bulging of the dilute compartments when higher dilute product recoveries are desired, and reduce membrane polarization effects.

### SUMMARY OF THE INVENTION

Accordingly, the present invention teaches spacers for use in electrodialysis and electrodeionization system which provide close contact between the spacer mesh and its adjacent ion exchange membranes. Their design can reduce the water flow cross-section through the cell, in turn leading to higher flow velocities and increased flow turbulence between ion exchange membranes, thereby reducing membrane polarization effects and increasing the limiting current density.

A first aspect of the invention provides a spacer for use in electrodialysis and electrodeionization systems, the spacer comprising: (a) a mesh component, the mesh component comprising a central mesh sheet shaped to define a plurality of protrusions, each of the plurality of mesh component protrusions including a hole; and (b) a gasket component comprising a gasket edge, the gasket edge defining an open central area for receiving the central mesh sheet and including a plurality of protrusions, each of the plurality of gasket edge protrusions including a hole, wherein the plurality of gasket edge protrusions defines a plurality of recesses within the gasket edge for receiving the plurality of mesh component protrusions, and wherein the gasket edge has substantially the same thickness as the central mesh sheet when the spacer is compressed within an electrodialysis/electrodeionization stack, thereby allowing close contact between the mesh component of the spacer and adjacent ion exchange membranes within the stack.

A second aspect of the invention provides a spacer for reducing ion exchange membrane polarization effects and increasing the limiting current density in an electrodialysis system, the electrodialysis system comprising: a stack of alternating pairs of ion exchange membranes, each ion exchange membrane creating a concentrate compartment on one side and a dilute compartment on the other side when the system is filled with a feed solution and acted upon by a direct current; a first electrode housed in a first endplate positioned on one side of the stack; a second electrode housed in a second endplate positioned on the other side of the stack; a plurality of input and output passages leading into and out of the endplates and the stack; and a direct current electric power supply for establishing a potential difference between the first electrode and the second electrode to cause the passage of electric current through the feed solution, wherein the spacer comprises: (a) a mesh component, the mesh component comprising a central mesh sheet shaped to define a plurality of protrusions, each of the plurality of mesh component protrusions including a hole; and (b) a gasket component comprising a gasket edge, the gasket edge defining an open central area for receiving the central mesh sheet and including a plurality of protrusions, each of the plurality of gasket edge protrusions including a hole, wherein the plurality of gasket edge protrusions defines a plurality of recesses within the gasket edge for receiving the plurality of mesh component protrusions, and wherein the gasket edge has substantially the same thickness as the central mesh sheet when the spacer is compressed within the stack, thereby allowing close contact between the mesh component of the spacer and adjacent ion exchange membranes within the stack.

The nature and advantages of the present invention will be more fully appreciated from the following drawings, detailed description, and claims.

### BRIEF DESCRIPTION OF THE DRAWINGS

The accompanying drawings illustrate the prior art and preferred embodiments of the invention and, together with a general description of the invention given above, and the detailed description given below, explain the principles of the invention.

FIG. 1 illustrates an ion exchange membrane with water passage holes on it;

FIG. 2 illustrates a prior art regular spacer in two orientations;

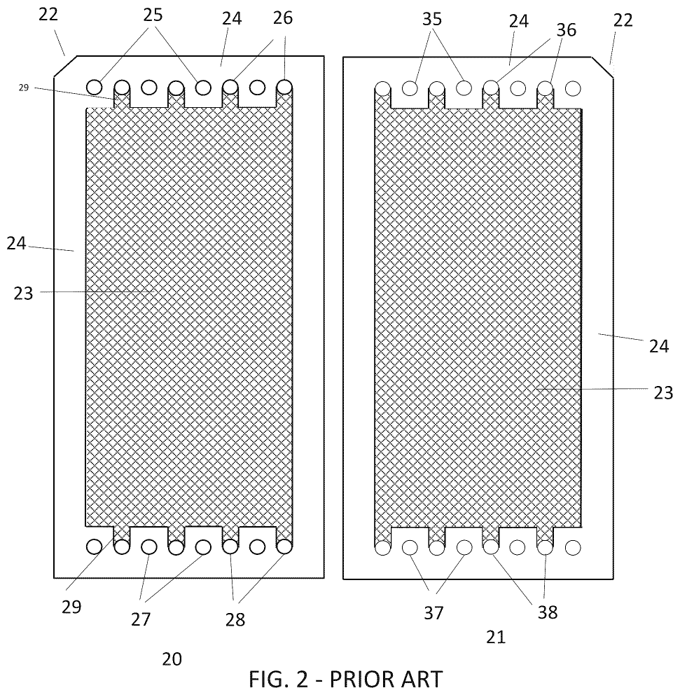

FIG. 3 illustrates an end spacer;

FIG. 4 illustrates a schematic presentation of an electrodialysis cell;

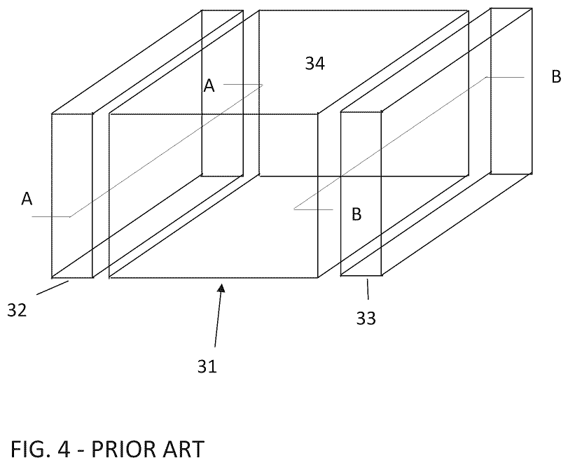

FIG. 5 illustrates a pattern of water conveyance passages on endplates;

FIG. 6 illustrates areas of low contact stress areas on prior art spacers;

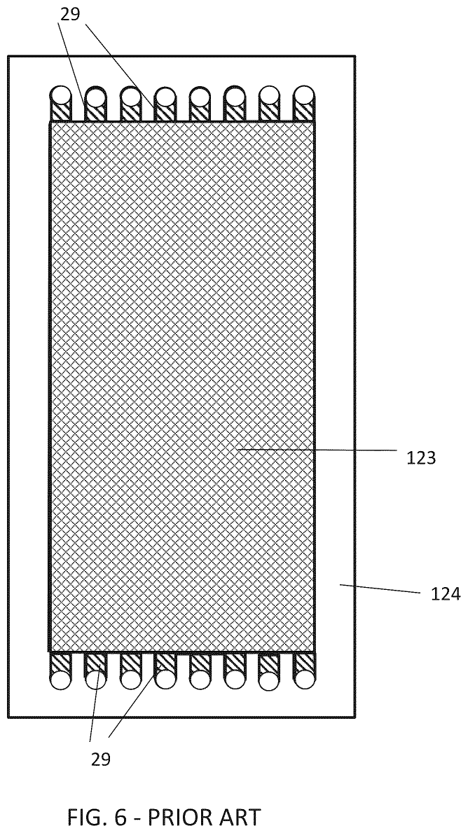

FIG. 7 illustrates the gasket and separate central mesh portion of one embodiment of the inventive spacer;

FIG. 8 illustrates two views of one embodiment of an assembled spacer according to the present invention; and

FIG. 9 illustrates a component of another embodiment of the inventive spacer.

### DETAILED DESCRIPTION OF THE INVENTION

The present invention improves on the prior art spacers used in electrodialysis and electrodeionization systems which provide close contact between the spacer mesh and its adjacent ion exchange membranes. Their design can reduce the water flow cross-section through the cell, in turn leading to higher flow velocities and increased flow turbulence between ion exchange membranes, thereby reducing membrane polarization effects and increasing the limiting current density.

Definitions—As defined herein, the terms “ion” or “ions” refer to an atom or molecule with a net electric charge due to the loss or gain of one or more electrons. In electrolytes, ions are hydrated ions which means that they are covered by a shell of water molecules. The amount of charge of an ion depends on the number of electrons lost or gained. For any ion missing or gaining one electron, the net charge is equals to that of an electron, equal to 1.60217662×10⁻¹⁹ Coulombs. This results in the fact that one mole of electrons is equivalent to Avogadro's number (6.02214×10²³) of electrons or 96,485.3 Coulombs.

As used herein, the terms “electrolyte” and “electrolyte solution” are interchangeable. The principals disclosed herein are therefore applicable to any solute or chemically defined salt or salt mixture dissolved in any polar liquid, wherein the result is the formation of an electrolyte solution. Therefore, when referring to ion-containing or salty waters, irrespective of the variety and concentration of the salts present in unit volume of the liquid, it is to be interpreted as to mean and include an electrolyte solution. As such the term water can mean any polar solvent and the term salt can mean any solute which together with a polar solvent forms an electrolyte solution.

As used herein the terms “ion exchange membrane” and “ion selective membrane” refer to semi-permeable membranes which can function as either cation-selective or anion-selective membranes; such terms are interchangeable when used in this document.

As used herein the terms “electroactive media” and “ion exchange resin beads” are interchangeable and may include any shapes or forms as long of they can perform the intended function of conducting ions in a sparingly conductive solution under the influence of an electric field, while maintaining sufficient mechanical integrity. Many types of electroactive media can be used to define a lower resistance path for ion flow in electrolytes acted upon by an electric field. The most common type is in the form of ion exchange resin beads, but electroactive media can also be in the form of beads bonded to one another by a bonding agent, or in the form of fabrics, and depending on the specifics of a design can be mixed anion and cation exchange beads or singular polarity bead layers filling one compartment or distinct sections of both types of resin beads in a single compartment.

As used herein, “gasketing material” used in manufacture of these invented spacers are meant to define any elastomer such as silicon rubber, neoprene, nitrile, PTFE, rubber, and various polymers such as polychlorotrifluoroethylene or other similar material that can form a sealing gasket sheet that could be used to manufacture the gasket part of the invented spacer. Any reference to elastomer material or silicone rubber in this document means “gasketing material” as defined here.

The terms “electrodeionization” and “electrodialysis” as they apply to specific processes used are technically different. As noted above, electrodeionization devices are typically used for production of higher purity products from higher purity feeds while electrodialysis systems are used to produce water for such uses as for human consumption or for agriculture from brackish waters and seawater, Further, electrodeionization systems may be distinguished from electrodialysis systems by incorporation of specific voluminous spacers (or separators) placed between the ion exchange membranes while electrodialysis devices typically use rather thin spacers made up a plastic mesh. Such spacers, as they apply to the present invention and electrodeionization devices, are typically filled with electroactive media such as ion exchange resin beads, which facilitate ion flow in the low conductivity input and sparingly conductive high purity output product which is generated in the dilute compartments. Further, while electrodialysis systems are typically used for input solutions having 1000 mg/liter and higher salt content, such as brackish water and seawater, electrodeionization systems typically are used for input solutions already having a low salt content, such as aqueous salt solutions that are the product of passing through one or more reverse osmosis systems. Typically, these feeds have conductivities of less than 50 μS/cm corresponding to about 18 to 20 ppm equivalent NaCl.

Improvements—The present invention improves on conventional prior art spacers used in electrodialysis systems by reducing/preventing gaps between the spacer mesh and the ion exchange membranes, which serves to prevent leakage from the dilute (i.e. low concentration) compartments to the concentrate (i.e. high concentration) compartments. The spacer embodiments disclosed herein can also prevent leakage from the concentrate compartments to the dilute compartments, when operational and design requirements require high pressure in the concentrating compartments.

The spacer embodiments disclosed herein allow the electrodialysis stack compartments to be filled, allowing for complete contact between the spacer's central mesh portion and its adjacent ion exchange membranes. This results in a reduced water flow cross-section through the stack, in turn leading to higher flow velocities and more turbulence in the water flow between ion exchange membranes, compared to spacers that do not make contact with their adjacent ion exchange membranes. This in turn can reduce or eliminate membrane polarization effects, and increase the limiting current density. When compressed, the spacer's gasketed edges have the same thickness as it's central mesh, such that current density and energy consumption are decreased.

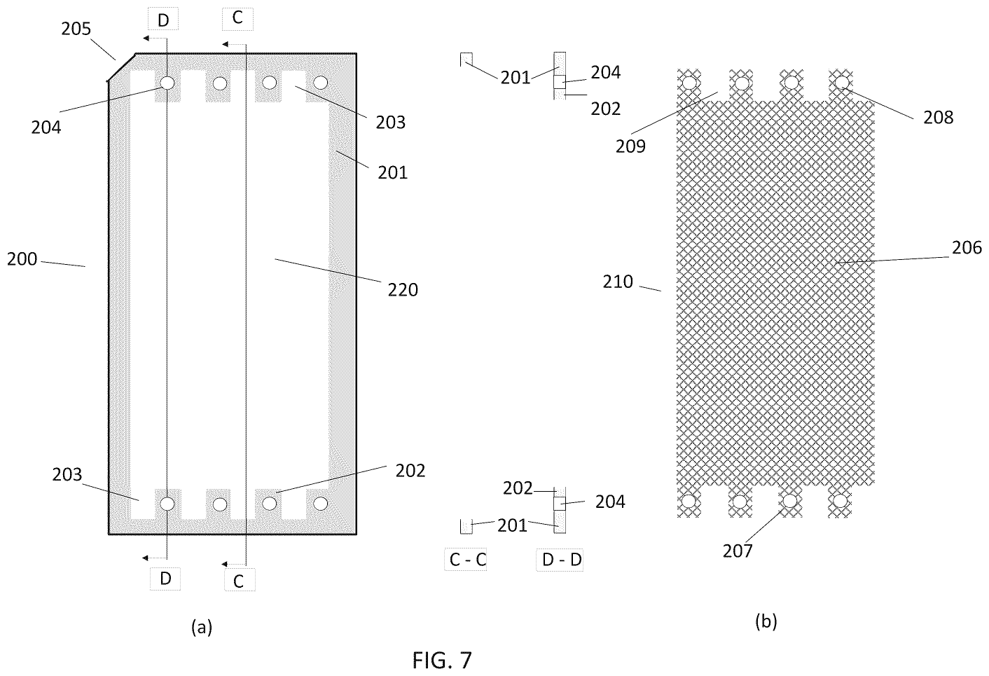

FIGS. 7a and 7b illustrate components which, when combined, constitute a preferred embodiment of the inventive spacer. The gasket component 200 of FIG. 7a includes holes 204 and is typically constructed by punching or cutting its shape from sheets of silicon rubber or similar elastomer material. Each gasket component 200 also typically includes what can be described as a plurality of extensions, flanges or protrusions 202, as well as a plurality of cut-outs or recesses 203 alternating with the protrusions 202, and a cut corner 205. FIG. 7a and its related cross-sections C-C and D-D show that the gasket component 200 includes a gasket edge 201 bounding, surrounding the perimeter of, or otherwise defining an open central area 220. The gasket component 200 is constructed to receive a central mesh sheet 206 of a mesh component 210, described below. FIG. 7a also illustrates that the gasket edge 201 also defines the gasket component's protrusions 202, recesses 203, holes 204, and cut corner 205. Typically the thickness of the gasket edge is between about 0.1 to 2.0 mm and more preferably between 0.2 mm and 1.0 mm.

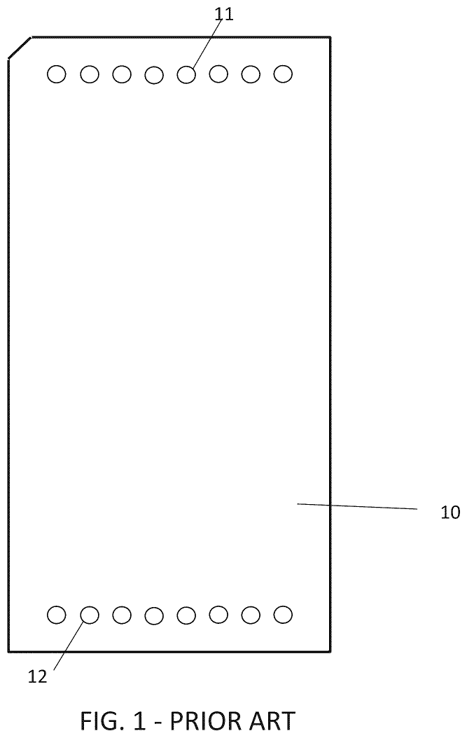

The mesh component 210 of the spacer is presented in FIG. 7b, which includes a cut-out of a central mesh sheet 206 made of a woven plastic or equivalent thereto as is known in the art, the sheet 206 being shaped to define a plurality of mesh protrusions 207 and cut-outs/recesses 209, each mesh protrusion including a hole 208. The central plastic mesh sheet 206 typically has a thickness of between 0.1 mm and 2.0 mm, and more preferably between 0.2 mm and 1.0 mm. The protrusions 207, and the mesh sheet 206 in general, are intended to fit into the open central area 220, including the recesses 203 of the surrounding edge 201 of the gasket 200 of FIG. 7a. It is noted that the dimensions of all of the recesses 203 and protrusions 207, including their holes 204, 208, are intended to be the same for every spacer throughout the stack, and arranged such that their holes 204, 208 match the holes 11 and 12 of their adjacent ion exchange membranes 10 (see FIG. 1).

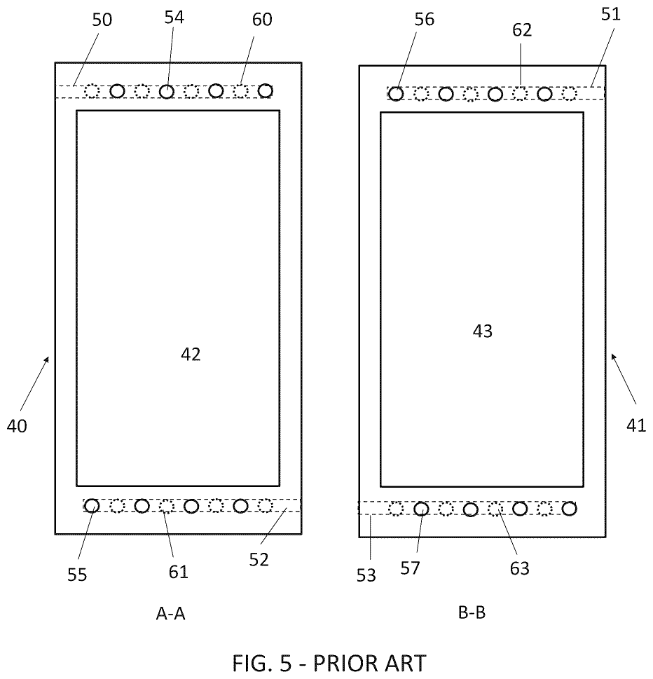

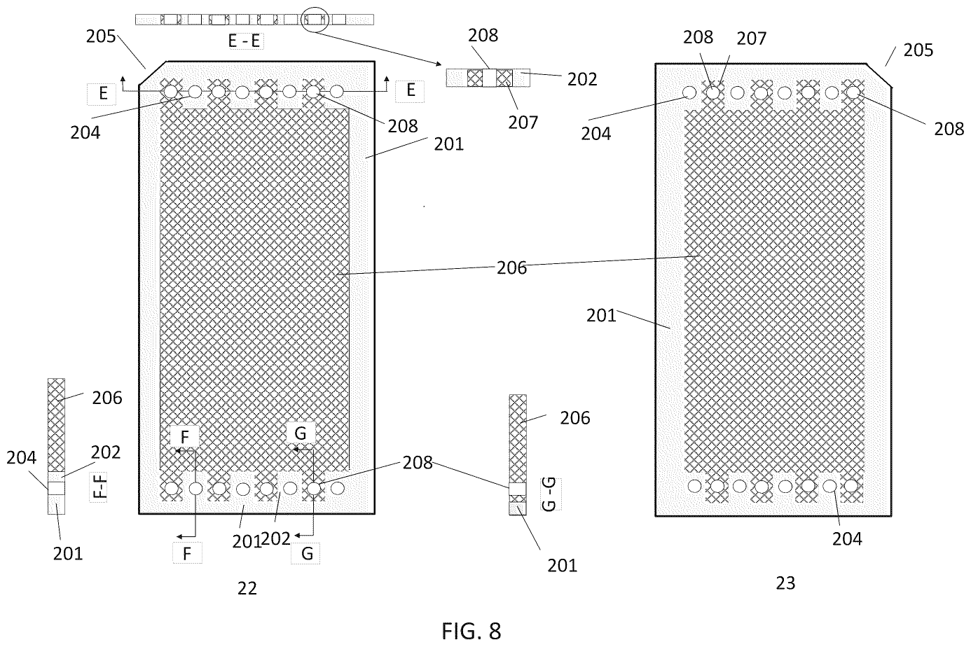

FIG. 8 illustrates two views 22 and 23 of the assembled spacer for use in electrodialysis cells, along with three sectional views E-E, F-F, and G-G. As noted above, each of the spacers 22, 23 are a combination of a gasket 200 and a central plastic mesh 206, as shown in FIGS. 7a and 7b. The spacers 22 and 23 are substantially the same if not identical mirror images of one another, with spacer 23 simply being spacer 22 flipped over or turned over along its longer side, as can be identified in FIG. 8 by the position of the triangular cuts 205. For use of the inventive spacers in any electrodialysis or electrodeionization cell, the dimensions of the spacers and the location of the holes 204, 208 should match the holes 11, 12 of the ion exchange membranes 10 (see FIG. 1), and the dimensions of the central plastic mesh 206 should match the cavities 42, 43 of the endplates 40, 41 (see FIG. 5), such that the holes 204 and protrusions 202 of the gasket 200, and the holes 208 and protrusions 207 of the central mesh component 210 can be supported by the endplates 40 and 41 which house the electrodes (not shown). Thus, in a completed stack, it is intended that the holes 11 and 12 of the ion exchange membranes 10 shown in FIG. 1 match up with the holes 204 and 208 of the spacers 22, 23 shown in FIG. 8, which match up with the water conveyance holes 54, 55, 56 and 57 at the top and bottom of the endplates 40 and 41 of FIG. 5, which in turn connect to water conveyance passages 50, 51, 52 and 53 entering from the sides of the endplates 40, 41.

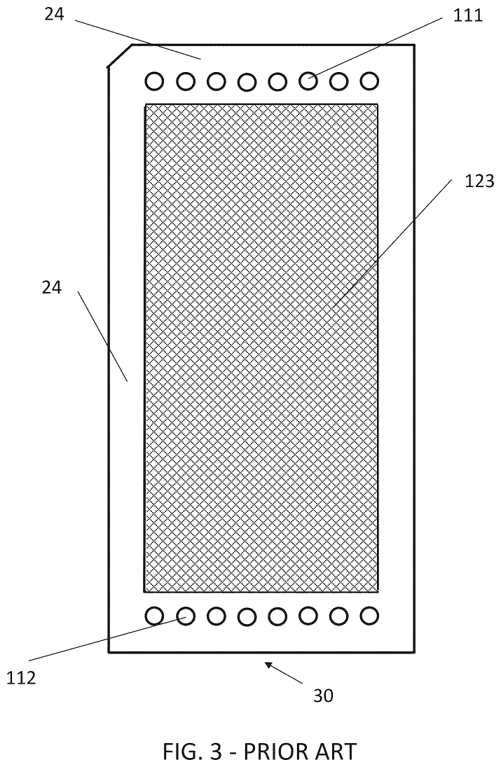

With the dimensions of the ion exchange membranes, the spacers, and the endplates matching as described above, the assembly of electrodialysis stacks using the inventive spacer can begin with an end spacer (30, see FIG. 3), followed by a first ion exchange membrane (10, see FIG. 1). A first gasket 200 is then placed on the first ion exchange membrane with holes and dimensional boundaries matching the ion exchange membrane and the endplate 40 (see FIG. 5). This is then followed by placement of the central plastic mesh 206 of the first spacer placed within the open central area 220 of the first gasket 200. Experience has shown that when the underlying membrane is wet, as is the norm, the surface tension of the water on the membrane helps the gasket and the mesh to easily adhere to the membrane for the duration of the time it takes to place the next membrane on them. This operation is then followed by placement of an oppositely charged membrane on the previous membrane-spacer arrangement followed by placement of the next gasket 200 with the cut corner 205 placed on the opposite side, followed by completion of the spacer by placement of its central plastic mesh 206 within the open central area 220 of the newly placed gasket 200, as before. This pattern is then repeated until the stack is completed with an end spacer at the other side.

As noted above, if the gaps between the spacer mesh and the ion exchange membranes can be reduced/prevented, this would result in a reduced water flow cross-section, leading to higher flow velocities and more turbulence in the water flow between ion exchange membranes. This in turn would reduce or eliminate any membrane polarization effects, and increase the limiting current density. Thus, in order to achieve perfect sealing between the dilute compartments and the concentrate compartments, and also to the outside of the stack, the thickness of the central plastic mesh 206 and the gasket edge 201 after compression within electrodialysis stack should be substantially the same. This is done by careful selection of the materials, their thicknesses and compressibility. In practice, the central mesh is slightly thinner than the gasket edge prior to compression. The resulting stack will have sealing edges between adjacent membranes at the locations of the gasket protrusions 202, and easy flow of water into and out of the compartments through the mesh sheet protrusions 207. Further, with the thickness of the gasket edges 201 and the central plastic mesh 206 being the same within the assembled and compressed stack, the ion exchange membranes 10 will be better supported, as there will be a minimal or no gap between them and the central plastic mesh 206 of the spacer. Furthermore, an electrodialysis stack assembled using the inventive spacer can have better seal between the compartments while reducing the flow cross-sections in both sets of compartments, thus reducing polarization effects and improving limited current density.

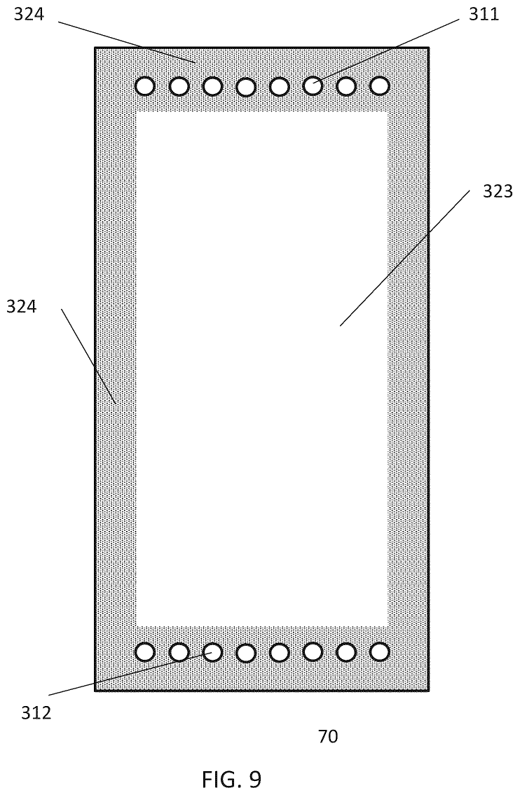

For electrodeionization cells where the spacers need to also house electroactive media to facilitate the flow of ions, the thickness of the inventive spacer can be increased. This can be done by placement of a voluminous spacer gasket 70, as shown inn FIG. 9. The gasket 70 can have a thickness compatible with the intended volume of the resin beads, ranging in thickness from a minimum of 2.0 to 3.0 mm to more than 10.0 mm. The gasket can accommodate resin beads, or any other equivalent shape or form of electroactive media placed on top of the spacer shown in FIG. 8. Like the gasket 200 in FIG. 8, the gasket 70 of FIG. 9 includes an outer gasket edge 324, an open central area 323, and holes 311, 312 on the top and bottom of the edge 324. The gasket 70 is typically constructed by punching or cutting its shape from sheets of silicon rubber or similar elastomer material. The dimensions and the position of the holes 311, 312 on this voluminous gasket 70 are intended to match the holes on the spacer of FIG. 8, as well as those of the ion exchange membranes (e.g., see FIG. 1) and endplates, as described in detail above. For assembly of an electrodeionization stack and after an end spacer and the first membrane, the spacer embodiment 22 of FIG. 8 is placed and is then followed by a voluminous gasket embodiment of FIG. 9 on top of the spacer, creating the required volume for placement of electroactive material. Once the electroactive material is placed in, the next membrane with opposite polarity with respect to the previous membrane would be placed on top of this new spacer assembly, followed by the spacer embodiment 23 of FIG. 8, with reverse orientation compared to the spacer embodiment 22 of FIG. 8, followed by another voluminous gasket embodiment of FIG. 9 and placement of electroactive media. This sequence is then repeated until the stack is completed with another end spacer.

Test Results—A plurality of the spacers illustrated in FIG. 8 were manufactured, each having a gasket component 200 including an edge 201 around the perimeter of an open central area 220, protrusions 202, recesses 203, holes 204, and a cut corner 205. The spacers 22, 23 had a height of about 15.0 cm and width of about 12.5 cm from the top gasket edge to the bottom edge, with three (3) protrusions 202 on both the top and the bottom of each gasket component, each protrusion being about 1.5 cm long and about 1.2 cm wide and having hole at their center about 5.0 mm in diameter. The open central area 220 of each gasket component, for receipt of the central mesh sheet 206 (see FIGS. 7a, 7b and 8), was about 10 cm wide and 9 cm in height. The silicone rubber used was about 0.4 mm thick, had a shore hardness of about 50, and was supplied by the American Rubber products of Santa Ana California. The central mesh sheets were each made of a punched woven plastic and included a plurality of protrusions 207 that matched the number and dimensions of the recesses 203 and the open central area of the gasket 200, and holes 208 which were the same diameter as the holes 204 of the gasket component 200. See, e.g., FIG. 8. The mesh used was a woven mesh with a thickness of about 0.39 mm, made in China using polyethylene yarns and purchased from Skycan Manufacturing Ltd. of Saskatchewan, Canada.

These spacers were used in an electrodialysis cell equipped with fifty (50) anion exchange membranes (AEM, Type 12) and fifty-one (51) cation exchange membranes (CEM, Type 12), purchased from Fujifilm of the Netherlands. High density polyethylene endplates, which housed the capacitive electrodes, measured about 5.0 cm in thickness and had a height of 18.0 cm and a width of 15.5 cm. The endplates were tightened by eight (8) one-quarter inch (¼ inch) bolts torqued to 25 in-lbs (2.825 newton meters). This cell was tested with a pressure of 1.5 Bars on one set of compartments and free flow on the other side. There were no external leaks observed, and the internal leaks were less than a maximum one ml per minute, which was far less than for a similar cell using prior art spacers. This cell functioned as expected with feeds TDS values ranging 1200 ppm to 15000 ppm with total feed flows ranging from 25 to 10 liters per hour respectively.

While the present invention has been illustrated by the description of embodiments and examples thereof, it is not intended to restrict or in any way limit the scope of the appended claims to such details. Additional advantages and modifications will be readily apparent to those skilled in the art. Accordingly, departures may be made from such details without departing from the scope of the invention.

What is claimed is:

1. A spacer for use in electrodialysis and electrodeionization systems, the spacer comprising:
a) a mesh component, the mesh component comprising a central mesh sheet shaped to define a plurality of protrusions, each of the plurality of mesh component protrusions including a hole; and
b) a gasket component, the gasket component comprising a gasket edge, the gasket edge defining an open central area for receiving the central mesh sheet and including a plurality of protrusions, each of the plurality of gasket edge protrusions including a hole, wherein the plurality of gasket edge protrusions defines a plurality of recesses within the gasket edge for receiving the plurality of mesh component protrusions, and wherein the gasket edge has substantially the same thickness as the central mesh sheet when the spacer is compressed within an electrodialysis/electrodeionization stack, thereby allowing close contact between the mesh component of the spacer and adjacent ion exchange membranes within the stack.

2. The spacer of claim 1, wherein the central mesh sheet has a thickness of between 0.1 mm and 2.0 mm, and wherein the thickness of the gasket edge is substantially the same as the mesh after compression within the stack.

3. The spacer of claim 1 in combination with a voluminous spacer gasket for receiving a volume of electroactive media, the voluminous spacer gasket comprising an outer gasket edge, an open central area for receiving the electroactive media, and holes on the top and bottom of the outer gasket edge, wherein the dimensions and the position of the holes of the voluminous spacer gasket match the holes on the spacer.

4. The spacer of claim 3, wherein the thickness of the outer gasket edge of the voluminous spacer gasket is greater than 2.0 mm.

5. The spacer of claim 1, wherein the gasket component comprises materials such as silicon rubber, nitrile rubber, plastic polymers, or other similar material.

6. A spacer for reducing ion exchange membrane polarization effects and increasing the limiting current density in an electrodialysis system, the electrodialysis system comprising: a stack of alternating pairs of ion exchange membranes, each ion exchange membrane creating a concentrate compartment on one side and a dilute compartment on the other side when the system is filled with a feed solution and acted upon by a direct current; a first electrode housed in a first endplate positioned on one side of the stack; a second electrode housed in a second endplate positioned on the other side of the stack; a plurality of input and output passages leading into and out of the endplates and the stack; and a direct current electric power supply for establishing a potential difference between the first electrode and the second electrode to cause the passage of electric current through the feed solution, wherein the spacer comprises:
a) a mesh component, the mesh component comprising a central mesh sheet shaped to define a plurality of protrusions, each of the plurality of mesh component protrusions including a hole; and
b) a gasket component comprising a gasket edge, the gasket edge defining an open central area for receiving the central mesh sheet and including a plurality of protrusions, each of the plurality of gasket edge protrusions including a hole, wherein the plurality of gasket edge protrusions defines a plurality of recesses within the gasket edge for receiving the plurality of mesh component protrusions, and wherein the gasket edge has substantially the same thickness as the central mesh sheet when the spacer is compressed within the stack, thereby allowing close contact between the mesh component of the spacer and adjacent ion exchange membranes within the stack.

7. The spacer of claim 6, wherein the central mesh sheet has a thickness of between 0.1 mm and 2.0 mm, and wherein the thickness of the gasket edge is substantially the same as the mesh after compression within the stack.

8. The spacer of claim 6 in combination with a voluminous spacer gasket for receiving a volume of electroactive media, the voluminous spacer gasket comprising an outer gasket edge, an open central area for receiving the electroactive media, and holes on the top and bottom of the outer gasket edge, wherein the dimensions and the position of the holes of the voluminous spacer gasket match the holes on the spacer.

9. The spacer of claim 8, wherein the thickness of the outer gasket edge of the voluminous spacer gasket is greater than 2.0 mm.

10. The spacer of claim 6, wherein the gasket component comprises materials such as silicon rubber, nitrile rubber, plastic polymers, or other similar material.
